(19) United States
(12) Patent Application Publication
(10) Pub. No.: US 2019/0103759 A1
(43) Pub. Date: Apr. 4, 2019

(54) POWER SUPPLY SYSTEM

(71) Applicants: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka-shi (JP)

(72) Inventor: Hisanori KAMBARA, Yokkaichi (JP)

(73) Assignees: AUTONETWORKS TECHNOLOGIES, LTD., Yokkaichi (JP); SUMITOMO WIRING SYSTEMS, LTD., Yokkaichi (JP); SUMITOMO ELECTRIC INDUSTRIES, LTD., Osaka-shi (JP)

(21) Appl. No.: 16/142,526

(22) Filed: Sep. 26, 2018

(30) Foreign Application Priority Data
Oct. 3, 2017 (JP) 2017-193465

(51) Int. Cl. H02J 9/06; H02J 7/00

(52) U.S. Cl. CPC H02J 9/061; H02J 7/007; H02J 7/0068

(57) ABSTRACT

A power supply system includes a high-potential end; a low-potential end; a power storage element including a positive terminal and a negative terminal, the negative terminal being connected to the low-potential end; a diode including an anode and a cathode, the cathode being connected to the high-potential end; a power source line connected between the anode and the positive terminal; and a first switch, connected in parallel to the diode, the first switch turning on when the power storage element is to be charged from the DC power source through the high-potential end or when a current value of discharge current flowing in the power source line from the positive terminal toward the anode is greater than or equal to a positive threshold, and the first switch turning off when the power storage element is not to be charged and the current value is less than the threshold.

This application claims priority from JP 2017-193465 filed Oct. 3, 2017, the entire disclosure of which is incorporated herein by reference.

### BACKGROUND

This disclosure relates to a technique for supplying power to a load, and particularly relates to a power supply system that functions as a backup power source for a DC power source.

JP-2017-70057A discloses a backup power source apparatus in which a charging circuit unit is provided in a charging path from a power supply input unit to a capacitor unit, and a booster circuit unit is provided in an output path from the capacitor unit to an output unit.

### SUMMARY

To realize the backup power source apparatus disclosed in JP-2017-70057A, converters are used for the charging circuit unit and the booster circuit unit. Because the apparatus requires a plurality of converters, the apparatus is expensive.

An exemplary aspect of the disclosure provides a backup power source or a sub-power source without converters or with only a single converter.

A power supply system supplies power to a load. The power supply system includes a high-potential end, a low-potential end, a power storage element, a diode, a power source line, and a switch. A positive voltage is applied to the high-potential end from a DC power source. The low-potential end outputs the power along with the high-potential end. The power storage element includes a positive terminal, and a negative terminal connected to the low-potential end. The diode includes an anode, and a cathode connected to the high-potential end. The power source line is connected between the anode and the positive terminal. The switch is connected to the diode in parallel. The switch turns on when the power storage element is to be charged from the DC power source through the high-potential end or when a current value of discharge current flowing in the power source line from the positive terminal toward the anode is greater than or equal to a positive threshold. On the other hand, the switch turns off when the power storage element is not to be charged and the current value is less than the threshold.

The power supply system, which does not use a converter or uses only one converter, functions as a backup power source or a sub-power source.

### BRIEF DESCRIPTION OF THE DRAWINGS

FIG. 1 is a block diagram illustrating the configuration of a power supply system according to a first embodiment.

FIG. 2 is a timing chart illustrating a relationship between current, switch operations, and a load power source.

FIG. 3 is a flowchart illustrating switch opening/closing operations.

FIG. 4 is a block diagram illustrating the configuration of a power supply system according to a second embodiment.

FIG. 5 is a flowchart illustrating switch opening/closing operations.

### DETAILED DESCRIPTION OF EMBODIMENTS

### First Embodiment

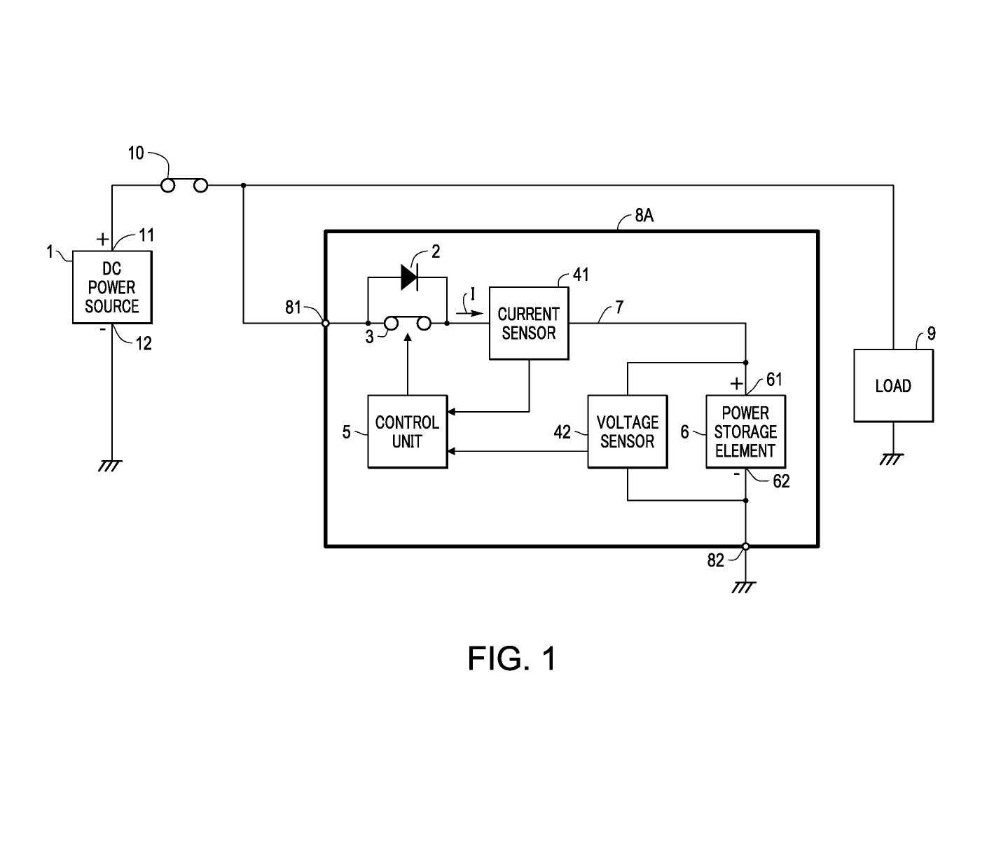

FIG. 1 is a block diagram illustrating the configuration of a power supply system 8A according to a first embodiment. FIG. 1 also illustrates a connection relationship between the power supply system 8A and peripheral elements thereof.

The power supply system 8A includes a high-potential end 81, and a low-potential end 82 that supplies power to a load 9 along with the high-potential end 81. Specifically, the high-potential end 81 is connected to one end of the load 9, and the low-potential end 82 is connected to the other end of the load 9. FIG. 1 illustrates an example in which both the other end of the load 9 and the low-potential end 82 are grounded.

A positive voltage is applied to the high-potential end 81 from a DC power source 1, through a switch 10. FIG. 1 illustrates a case where a positive terminal 11 of the DC power source 1 is connected to the high-potential end 81 through the switch 10, and a negative terminal 12 of the DC power source 1 is grounded. The switch 10 can be realized using a relay.

Assuming the power supply system 8A is installed in a vehicle, an alternator, a converter, or a lead storage battery can be given as an example of the DC power source 1. The load 9 is a load that desirably can be assured of operation even if the DC power source 1 malfunctions, such as an actuator, a sensor, or the like for steering or braking, for example.

The power supply system 8A further includes a diode 2, a switch 3, a power storage element 6, and a power source line 7. The power storage element 6 includes a positive terminal 61 and a negative terminal 62. The negative terminal 62 is connected to the low-potential end 82.

The power storage element 6 is capable of charging and discharging power, and is, for example, a lithium-ion battery, an electric double-layer capacitor, or the like.

The power source line 7 is connected between the anode of the diode 2 and the positive terminal, 61. The cathode of the diode 2 is connected to the high-potential end 81. The switch 3 is connected to the diode 2 in parallel. The switch 3 can be realized using a relay.

The switch 3 opens/closes depending on the value of current I flowing in the power source line 7 from the positive terminal 61 toward the anode (the current I being a discharge current of the power storage element 6 when positive), and depending on whether or not the power storage element 6 is charged. Controlling the opening/closing of the switch 3 will be described next using a timing chart and a flowchart.

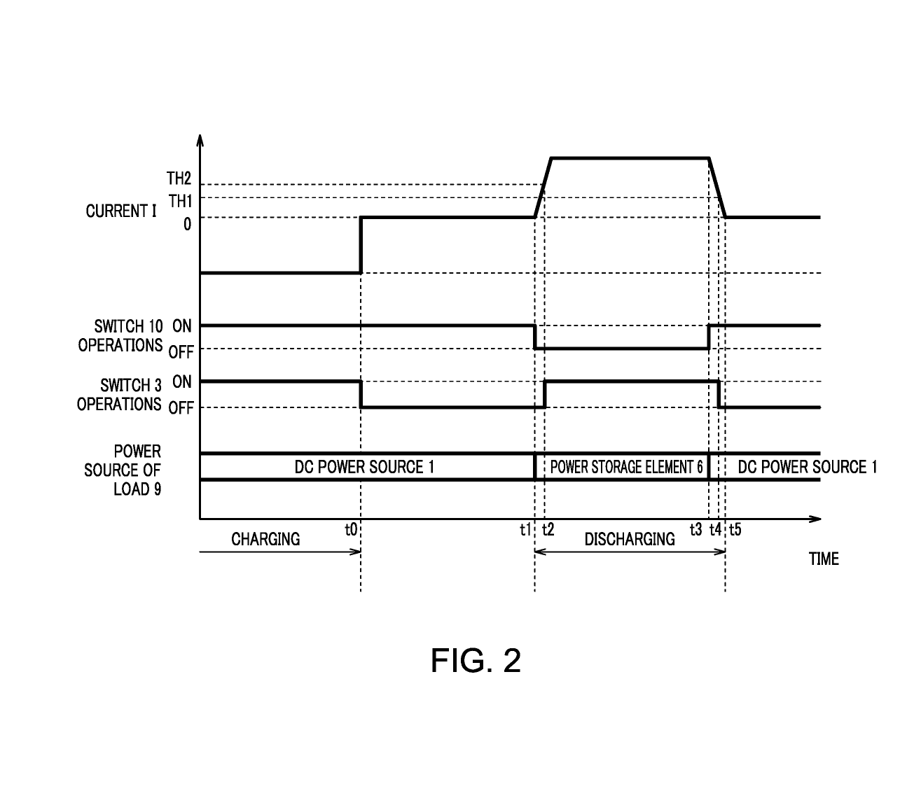

FIG. 2 is a timing chart illustrating a relationship between the current I, operations of the switches 3 and 10, and a power source of the load 9. FIG. 2 indicates whether the switches 3 and 10 are on or off by the ON and “OFF” levels. The period where the power source of the load 9 is denoted as “DC power source 1” indicates that power is supplied from the DC power source 1 to the load 9. The period where the power source of the load 9 is denoted as “power storage element 6” indicates that power is supplied from the power storage element 6 to the load 9.

Prior to time t0, the switches 3 and 10 are on, and the DC power source 1 charges the power storage element 6 through the switches 3 and 10 until time t0 is reached. The current I has a negative value while the power storage element 6 is charging. The DC power source 1 supplies power to the load 9 through the switch 10 even while the power storage element 6 is charging.

Time t0 is a time at which the charging of the power storage element 6 is complete. The switch 3 turns on in response to the charging of the power storage element 6 being complete. The current I stops flowing as a result. (indicated by “0” in FIG. 2).

When a malfunction, e.g., a voltage drop, arises in the DC power source 1, the switch 10 is turned off using a known technique. Time t1 to) is the time when the switch 10 turns off. The switch 3 is off from time t0 on. However, the diode 2 allows the current I to flow from the power storage element 6 to the high-potential end 81. The current I begins to flow in response to the DC power source 1 malfunctioning and the current flowing from the DC power source 1 to the load 9 decreasing. When the switch 10 turns off, the power source of the load 9 switches from the DC power source 1 to the power storage element 6.

Time t2 (>t1) is the time of an event in which the current I has risen from a value less than a threshold TH2 to a value greater than or equal to the threshold TH2 (referred to as a “rising event” hereinafter). To rephrase, the malfunction in the DC power source 1 is detected through the rising event. The switch 3 turns on in response to the rising event. For the sake of simplicity, FIG. 2 ignores a delay time from after the rising event has occurred to when the switch 3 turns on (referred to as an “on delay time” hereinafter), and indicates the switch 3 as transitioning from off to on at time t2. The value of the current I flowing through the switch 3 is from 50 to 100 A, for example.

Thereafter, once the DC power source 1 has been restored from the malfunction, the switch 10 is turned on through a known technique. Time t3 t2) is the time at which the switch 10 turns on. When the switch 10 turns on, the power source of the load 9 switches from the power storage element 6 to the DC power source 1.

The supply of current from the DC power source 1 to the load 9 starts at time t3, and thus the value of the current I begins to drop. Time t4 (>t3) is the time at which the current I has dropped from a value greater than or equal to a threshold TH1 to a value less than the threshold TH1 (referred to as a “falling event” hereinafter). To rephrase, the DC power source 1 being restored from the malfunction is detected through the falling event. The switch 3 turns off in response to the falling event. For the sake of simplicity, FIG. 2 ignores a delay time from after the falling event has occurred to when the switch 3 turns off (referred to as an “off delay time” hereinafter), and indicates the switch 3 as transitioning from on to off at time t4.

The current I continues to fall thereafter, and stops flowing at time t5 (indicated by “0” in. FIG. 2). The power storage element 6 discharges during the period from time t1 to time t5.

In this manner, the power supply system 8A, which does not use a converter, functions as a backup power source or a sub-power source.

FIG. 2 illustrates an example in which the threshold TH2 employed when the current value rises is higher than the threshold TH1 employed when the current value falls. In other words, two types of thresholds are set as thresholds at which the switch 3 turns on and off, namely a first threshold (the threshold TH1) employed when the value of the current I is dropping, and a second threshold (the threshold TH2) employed when the value of the current I is rising. FIG. 2 illustrates an example in which the second threshold is higher than the first threshold. Setting the threshold TH2 higher than the threshold TH1 makes it possible to reduce the occurrence of chattering in the switch 3. When the switch 3 turns off through the falling event, there are cases where the potential at the cathode of the diode 2 drops below the potential at the anode and the current I increases slightly. If TH1 is equal to TH2, the slight increase in the current I will correspond to the above-described rising event, and the switch 3 will turn on as a result. This causes the occurrence of chattering in the switch 3.

The value of the current I can be detected using a current sensor 41 provided in the power source line 7. The current sensor 41 can be realized through a known configuration. For example, a shunt resistor that produces a drop in voltage transformed to a current value may be used. The current sensor 41 communicates that current value to a control unit. 5.

The on/off operations of the switch 3 can be controlled by the control unit 5. The control unit 5 controls the on/off operations of the switch 3 by comparing the value of the current I with the thresholds TH1 and TH2, and also depending on whether or not the power storage element 6 is charging.

The control unit can determine whether or not the power storage element 6 is charging by obtaining a voltage value of the power storage element 6. FIG. 1 illustrates an example in which a voltage sensor 42 is used. The voltage sensor 42 communicates that voltage value to the control unit 5.

It can be said that the control unit 5 controls the on/off operations of the switch 3 in accordance with the results of comparing the value of the current I with the thresholds TH1 and TH2, and the result of comparing the voltage value of the power storage element with the voltage value indicating that charging is complete.

Thus the power supply system 8A can be considered to further include the current sensor 41, the voltage sensor 42, and the control unit 5.

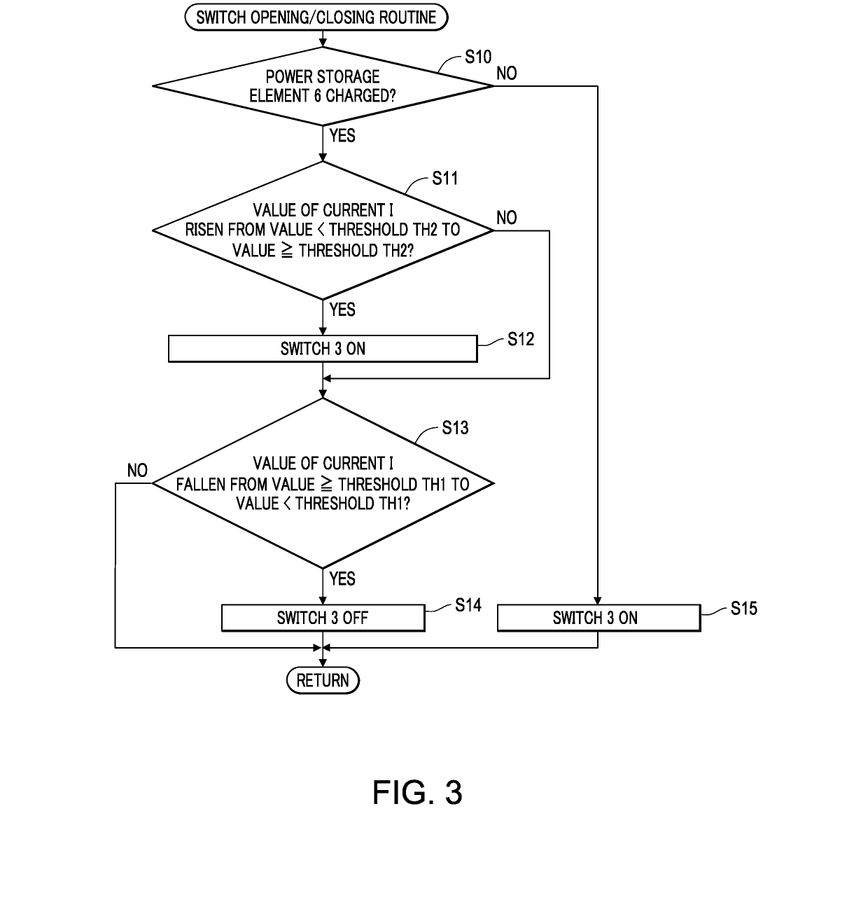

FIG. 3 is a flowchart illustrating opening/closing operations of the switch 3. This flowchart is illustrated as an example of a switch opening/closing routine, which is a subprogram of a main program (not illustrated). The subprogram is executed as an interrupt process for the main program, for example, and the processing returns to the main program when the subprogram ends.

The timing at which the value of the current I is obtained has been omitted from FIG. 3 for the sake of simplicity. However, the current value is obtained as appropriate, at a time required for the processing of the switch opening/closing routine The switch opening/closing routine is executed repeatedly during a period shorter than a period required for the interval for controlling the on/off operations of the switch 3.

The switch opening/closing routine is executed by the control unit 5, for example. Step S10 is executed first upon the switch opening/closing routine being started. In step S10, it is determined whether the power storage element 6 is charged. In terms of FIG. 2, a negative determination (“No” in FIG. 3; the same applies hereinafter) is made before time t0, and the process then moves to step S15.

The switch 3 is turned m in step S15. The switch opening/closing routine ends after step S15 (the processing returns to the main program).

If the switch opening/closing routine is executed after time t0, a positive determination (“Yes” in FIG. 3; the same applies hereinafter) is made in step S10, and the process moves to step S11.

In step S11, it is determined whether or not the rising event has occurred. Specifically, it is determined whether the value of the current I has risen from a value less than the threshold TH2 to a value greater than or equal to the threshold TH2. In terms of FIG. 2, a negative determination is made before time t2 and the process then moves to step S13.

In step S13, it is determined whether or not the falling event has occurred. Specifically, it is determined whether the value of the current I has risen from a value greater than or equal to the threshold TH1 to a value less than the threshold TH1. In terms of FIG. 2, a negative determination is made before time t4, and the switch opening/closing routine ends.

Then, if the switch opening/closing routine is executed from time t2 on, a positive determination is made in step S11, and the process moves to step S12. The switch 3 is turned on in step S12. The time following the occurrence of the rising event and leading up to the execution of step S12 is included in the on delay time.

After step S12 is executed, a negative determination is made in step S13, and the switch opening/closing routine ends. If the switch opening/closing routine is restarted after step S12 has been executed, a negative determination is made in step S11. However, before time t4, a negative determination is made in step S13, and the switch opening/closing routine ends with the switch 3 remaining on.

If the switch opening/closing routine is executed after time t4, the process moves from step S11 to step S13. A positive determination is made in step S13, and the process moves to step S14. The switch 3 is turned off in step S14. The time following the occurrence of the falling event and leading up to the execution of step S14 is included in the off delay time. The switch opening/closing routine ends after step S14 is executed.

If the switch opening/closing routine is restarted after step S14 has been executed, a negative determination is made in step S13, but the switch opening/closing routine ends with the switch 3 remaining off.

### Second Embodiment

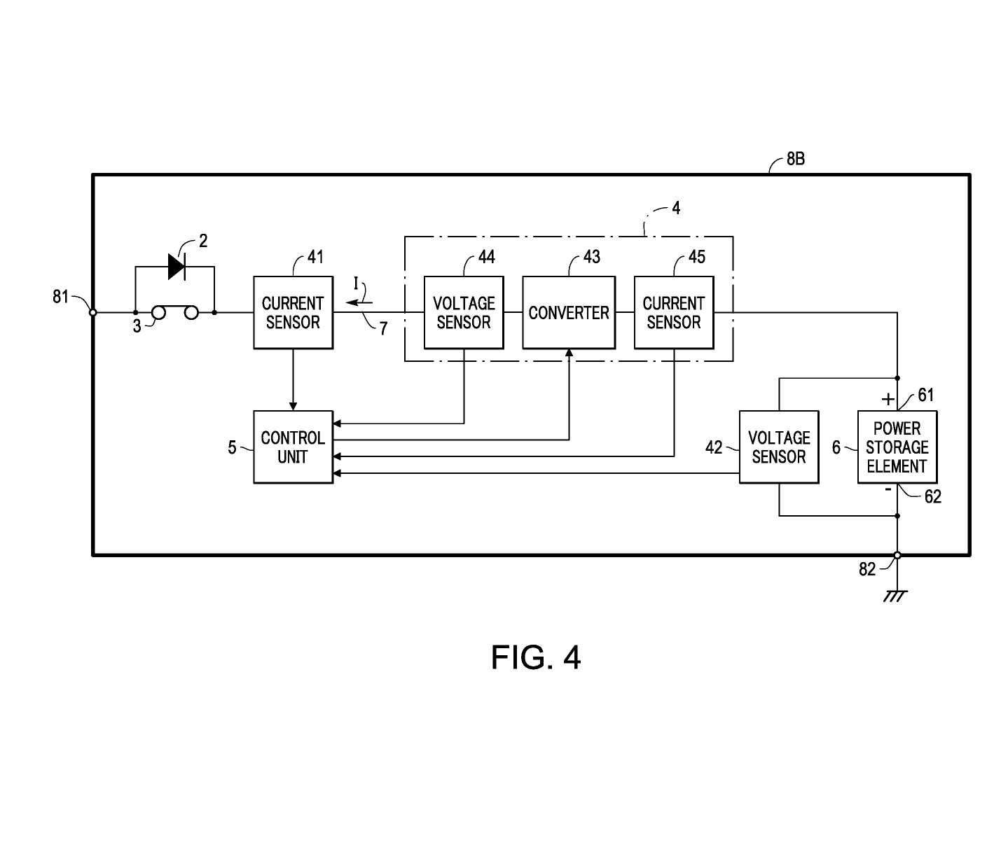

FIG. 4 is a block diagram illustrating the configuration of a power supply system 8B according to a second embodiment. The power supply system 8B can be used as a replacement for the power supply system 8A of the first embodiment.

The power supply system 8B has a configuration equivalent to adding a charging/discharging circuit 4 in the power source line 7 of the power supply system 8A.

The charging/discharging circuit 4 includes a converter 43. The converter 43 charges the power storage element 6 with current supplied from the DC power source 1 (see FIG. 1), through the switch 10, the high-potential end 81, and the switch 3. The converter 43 steps up or steps down the voltage of the power storage element 6 and outputs that voltage, which is output to the anode of the diode 2. The converter 43 may be a step-up converter, a step-down converter, or a dual converter.

The charging/discharging circuit 4 also includes a voltage sensor 44 that detects the output voltage of the converter 43. The voltage sensor 44 communicates the value of the output voltage to the control unit 5.

The control unit 5 controls the converter 43 so that the output voltage of the converter 43 is higher than a first voltage and lower than a second voltage. The first voltage is a minimum voltage value at which the load 9 can operate. The second voltage is higher than the first voltage, and corresponds to the potential of the high-potential end 81 when charging the power storage element 6.

The second voltage can be called a positive voltage applied to the high-potential end 81 when the DC power source 1 is operating normally.

Having the output voltage of the converter 43 higher than the first voltage ensures that the power needed for the load 9 to operate is supplied from the power supply system 8B to the load 9. Having the output voltage of the converter 43 lower than the second voltage suppresses reverse current from the power supply system 8B to the DC power source 1.

The charging/discharging circuit 4 may include a current sensor 45. The current sensor 45 detects charging current flowing to the power storage element 6, and communicates that current value to the control unit 5. The control unit 5 controls the converter 43 so that the charging current does not become overcurrent.

In this manner, the power supply system 8B, which uses the one converter 43, functions as a backup power source or a sub-power source.

### First Variation

When the switch 3 is turned off, all of the current I flows to the diode 2. It is thus desirable that both the thresholds TH1 and TH2 be set to currents lower than the permissible current of the diode 2. The thresholds TH1 and TH2 are set to from 10 to 20 A, for example.

### Second Variation

The control unit 5 may control the on/off operations of the switch 10. In this case, an additional voltage sensor that communicates the voltage at the positive terminal 11 to the control unit 5 may be provided (not shown here).

### Third Variation

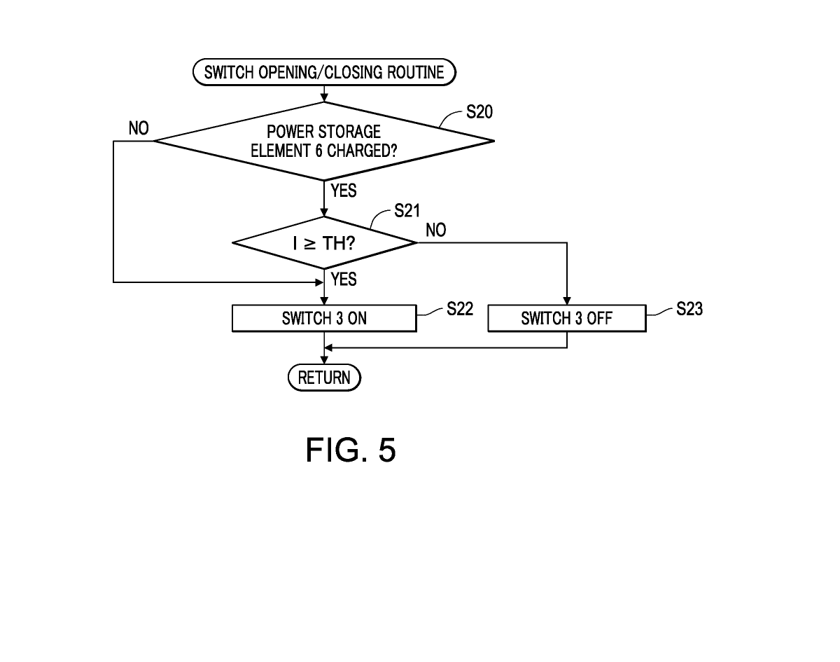

If it is not necessary to suppress chattering in the switch 3, the thresholds TH1 and TH2 need not be set to different values. FIG. 5 is a flowchart illustrating opening/closing operations of the switch 3, as the switch opening/closing routine, in a situation where both the thresholds TH1 and TH2 are set to the same value TH.

it is determined whether or not the power storage element 6 has been charged in step S20, in the same manner as in step S10. The process moves to step S22 if a negative determination is made. The switch 3 is turned on in step S22, in the same manner as step S12.

If a positive determination is made in step S20, the process moves to step S21.

In step S21, it is determined whether the value of the current I is greater than or equal to the threshold TH. If a positive determination is made in step S21, the switch 3 is turned on in step S22, if a negative determination is made in step S21, the switch 3 is turned off in step S23.

As such, the switch 3 is turned on if the power storage element 6 has not been charged. It can be said that if the power storage element 6 has been charged, the switch 3 is turned on when the value of the current I is greater than or equal to the positive threshold TH2, and is turned off when the value of the current I is less than the threshold TH1. From a different perspective, it can be said that the switch 3 is turned on when the power storage element 6 is to be charged or the value of the current I is greater than or equal to the positive threshold TH2, and is turned off when the power storage element 6 is not to be charged and the value of the current I is less than the positive threshold TH1

TH1=TH2 corresponds to the third variation, whereas TH2>TH1 corresponds to the above-described embodiments. However, as described above, the threshold TH1 is employed when the current value decreases, whereas the threshold TH2 is employed when the current value increases.

The configurations described in the above embodiments and variations can be combined as appropriate as long as the configurations do not conflict with each other.

While the disclosure has been described in detail above, the foregoing descriptions are in all ways exemplary, and the disclosure is not intended to be limited thereto. It is to be understood that countless variations not described here can be conceived of without departing from the scope of the disclosure.

What is claimed is:

1. A power supply system that supplies power to a load, the system comprising:
a high-potential end to which a positive voltage is applied from a DC power source;
a low-potential end that outputs the power along with the high-potential end;
a power storage element including a positive terminal and a negative terminal, the negative terminal being connected to the low-potential end;
a diode including an anode and a cathode, the cathode being connected to the high-potential end;
a power source line connected between the anode and the positive terminal; and
a first switch, connected in parallel, to the diode, the first switch turning on when the power storage element is to be charged from the DC power source through the high-potential end or when a current value of discharge current flowing in the power source line from the positive terminal toward the anode is greater than, or equal to a positive threshold, and the first switch turning off when the power storage element is not to be charged and the current value is less than the threshold.

2. The power supply system according to claim 1,
wherein two types of the threshold are set, the two types being a first threshold employed when the current; value is decreasing and a second threshold employed when the current value is increasing; and
the second threshold is higher than the first threshold.

3. The power supply system according to claim 1,
wherein the threshold is set to be less than or equal to a permissible current of the diode.

4. The power supply system according to claim 1, further comprising:
a current sensor that detects the current value; and
a control unit that controls on/off operations of the first switch on the basis of a result of comparing the current value to the threshold.

5. The power supply system according to claim 4, further comprising:
a first voltage sensor that detects a voltage value of a voltage of the power storage element,
wherein the control unit controls the on/off operations of the first switch by determining whether or not the power storage element is to be charged on the basis of the voltage value.

6. The power supply system according to claim 4, further comprising:
a converter that steps up or steps down a voltage of the power storage element and outputs the voltage, and outputs an output voltage to the anode; and
a second voltage sensor that detects the output voltage,
wherein the control unit controls the converter so that the output voltage is higher than a first voltage and lower than a second voltage;
the first voltage is a minimum voltage value at which the load can operate; and
the second voltage is higher than the first voltage, and corresponds to a potential of the high-potential end when charging the power storage element.

7. The power supply system according to claim 1,
wherein the high-potential end and the load are connected to the DC power source by a second switch; and
the second switch is on when the DC power source is functioning normally and off when the DC power source is malfunctioning.
